(19) United States
(12) Patent Application Publication
(10) Pub. No.: US 2017/0178055 A1
(43) Pub. Date: Jun. 22, 2017

(54) COLLABORATIVE PLANNING

(71) Applicant: International Business Machines Corporation, Armonk, NY (US)

(72) Inventors: Spyros Kotoulas, Dublin (IE); Rosemary K. Martin, Churchtown (IE); Marco L. Sbodio, Dublin (IE); Pierpaolo Tommasi, Dublin (IE)

(21) Appl. No.: 14/970,864

(22) Filed: Dec. 16, 2015

(51) Int. Cl. G06Q 10/06; G06F 17/30

(52) U.S. Cl. CPC G06Q 10/063118; G06F 17/30917; G06Q 10/063112

(57) ABSTRACT

An aspect of collaborative planning includes receiving plan drivers that collectively span multiple knowledge domains, and receiving user profiles, each of which specifies domain-specific data elements attributed to corresponding users who are tasked with carrying out the plan. The domain-specific data elements correspond to the multiple knowledge domains. An aspect further includes mapping each of the drivers to the users based on a relationship between the driver and the corresponding domain-specific data elements, and assigning actions to each mapped driver. For each of the users, an aspect includes creating a customized computer-implemented view of the plan that includes a user-directed corresponding mapped driver and a corresponding assigned action. An aspect also includes creating, for collective viewing by the users, a global computer-implemented view of the plan that is created from adapting each of the mapped drivers and corresponding assigned actions to a generalized level based on collective user profiles.

### BACKGROUND

The invention relates generally to information processing, and more specifically, collaborative planning in a multi-knowledge domain environment.

Planning has been defined as a process of evaluating a prospective endeavor and organizing actions that are needed to achieve some goal. A plan can be as simple as an ordered listing of actions to be taken, or may be more complex (e.g., multiple stages of execution and tests taken along the way to determine if the plan is on track).

### SUMMARY

According to embodiments a method, system, and computer program product for collaborative planning in a multi-knowledge domain environment is provided. A method includes receiving, at a computer, a set of plan drivers for creating a collaborative plan. The set of plan drivers collectively span multiple knowledge domains. The method also includes receiving a set of user profiles, each of which specifies domain-specific data elements attributed to corresponding users who are tasked with carrying out aspects of the collaborative plan. The domain-specific data elements correspond to one or more of the multiple knowledge domains. The method further includes mapping, by the computer, each of the plan drivers to one or more of the users based on a relationship between the plan driver and the corresponding domain-specific data elements of the one or more users, and assigning one or more actions to each mapped plan driver. The actions are configured to facilitate an objective defined via the collaborative plan. For each of the users, the method includes creating a customized computer-implemented view of the collaborative plan, which includes a user-directed corresponding one or more mapped plan driver and a corresponding one or more assigned action, and creating, for collective viewing by the users, a global computer-implemented view of the collaborative plan. The global view is created from adapting each of the mapped plan drivers and corresponding assigned actions to a generalized level that is based on collective user profiles.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a block diagram of a system upon which collaborative planning may be implemented in accordance with an embodiment of the invention;

FIG. 2 depicts a flow diagram of a process for collaborative planning in accordance with an embodiment of the invention;

FIG. 3 depicts a graphical representation of a hierarchy of terms created from knowledge domains according to an embodiment of the invention;

FIG. 4 depicts a graphical representation of a hierarchy of plan drivers created for a subject of a collaborative plan according to an embodiment of the invention;

FIG. 5A depicts a graphical representation of a hierarchy of the plan drivers of drivers of FIG. 4 and associations between the plan drivers and a particular user profile according to an embodiment of the invention;

FIG. 5B depicts a graphical representation of the hierarchy of FIG. 5A adapted to mask data determined to be unrelated and/or privileged with respect to the particular user profile according to an embodiment of the invention;

FIG. 5C depicts a graphical representation of a hierarchy of the plan drivers in FIG. 4 and associations between the plan drivers and another particular user profile according to an embodiment of the invention;

FIG. 6A depicts a graphical representation of the hierarchy of FIG. 5B including a selected action for a plan driver according to an embodiment of the invention; and

FIG. 6B depicts a graphical representation of the hierarchy of FIGS. 5B and 6A including a hierarchy of actions corresponding to a selected plan driver according to an embodiment.

### DETAILED DESCRIPTION

Complex planning problems can involve many domain experts. For example, considering a collaborative planning group that facilitates social and health care services for members of a community, the domain experts may include individuals having knowledge in the medical field, social care, education, and law enforcement, to name a few. A given subject of a collaborative plan can be associated with a vast amount of information from many different data sources, in which domain experts sift through the data to determine which aspects of data are relevant to their objectives. In addition, there may be some data about the subject that is considered sensitive information and should not be made generally available to every domain expert unless needed by the domain expert to achieve one or more objectives of the collaborative plan. The exemplary collaborative planning described herein enables individuals having domain expertise across a multitude of different knowledge domains to collaborate on the development of a plan by receiving or accessing only information that is relevant and necessary to that domain expert. The collaborative planning processes provide customized views of a plan directed to each domain expert, as well as provide a global view of the plan at a level of generalization that prevents unnecessary exposure of sensitive information.

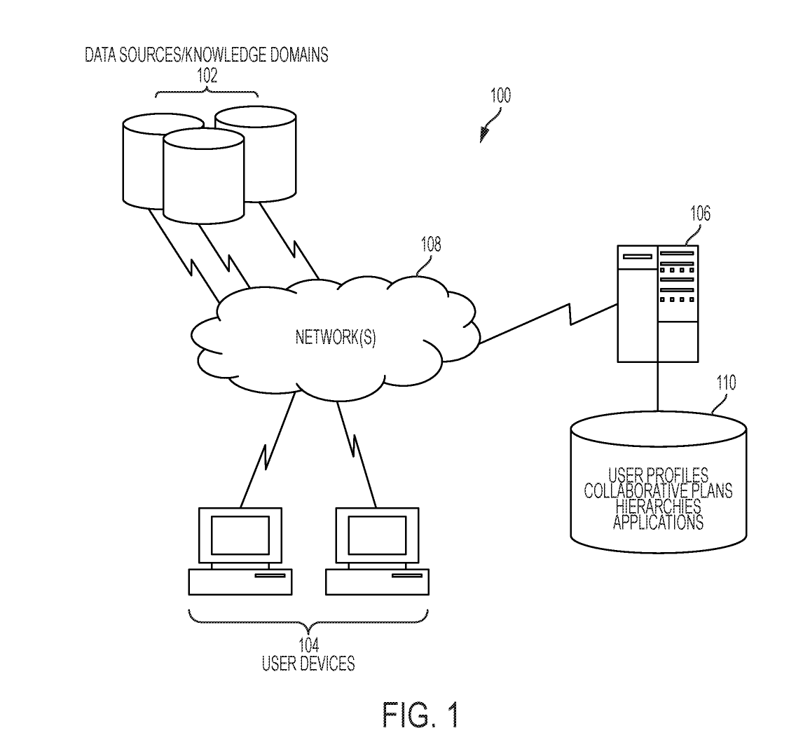

Turning now to FIG. 1, a system 100 upon which collaborative planning may be implemented will now be described in accordance with an embodiment. While embodiments are described herein as being directed to collaborative planning in a health care/social care environment for purposes of illustration, it will be understood that other areas and industries may be benefit from the collaborative planning processes described herein. For example, urban infrastructure planning may require many different domain experts in different fields to collaborate on a building or development project.

The system 100 of FIG. 1 includes storage devices 102, user devices 104, and a host computer 106, each of which is communicatively coupled to one or more networks 108. The storage devices 102 include databases of data that span multiple domains. Using the example above with respect to health and social care, one set of storage devices may store public safety records, another set of storage devices may store patient medical records, and another set of storage devices may store social care records with respect to members of a community. In an embodiment, the storage devices 102 may be part of a network platform that is managed through one or more management applications. For example, in the health and social care fields, the management applications may include Cúram® software solutions offered through IBM®.

In an embodiment, at least a portion of the storage devices 102 may store various domain-related taxonomies that can be processed for use in implementing the collaborative planning described herein. The taxonomies can be selected based on the type of planning involved.

The user devices 104 may be implemented by individuals who are tasked with executing a collaborative plan. In some embodiments, the individuals may provide input to the process to facilitate development of the collaborative plan. The individuals may be professionals who are educated and/or skilled in providing various tasks that are associated with the plan. In some cases, the individuals may be considered experts in a particular domain. Using the health and social care example above, the individuals operating the user devices 104 may include physicians, nurses, social workers, public safety officers, and educators. Each of the user devices 104 may be implemented as personal computers (e.g., desktop, laptop) or may be portable devices (e.g., smart phones, tablet computers, personal digital assistants, etc.). The user devices 104 access the host system computer 106 to view, and in some embodiments provide input to, a collaborative plan developed for a particular subject.

The host system computer 106 may be implemented as a high-speed computer processing device capable of handling the volume of activities conducted between the user devices 104 and the storage devices 102. The host system computer 106 may be operated by an entity that provides the collaborative planning as a service to others. For example, the host system computer 106 may execute one or more applications to coordinate with the storage devices 102, as well as the user devices 104, to generate collaborative plans. A storage device 110, which stores user profiles, previously developed collaborative plans, hierarchies, and applications, is accessible by the host system computer 106 for facilitating the collaborative planning processes described herein.

The storage device 110, as well as storage devices 102, may be implemented using a variety of devices for storing electronic information. It is understood that the storage device 110 may implemented using memory contained in the host system computer 106 or it may be a separate physical device, as illustrated in FIG. 1. The storage devices 102 and 110 may be logically addressable as consolidated data sources across a distributed environment that includes one or more networks, such as networks 108. Information stored in the storage devices 102 and 110 is retrieved and manipulated via the host system computer 106, as well as by end users of the collaborative planning processes.

The networks 108 may be any type of known networks including, but not limited to, a wide area network (WAN), a local area network (LAN), a global network (e.g. Internet), a virtual private network (VPN), and an intranet. The networks 108 may be implemented using wireless networks or any kind of physical network implementation known in the art, e.g., using cellular, satellite, and/or terrestrial network technologies. The networks 106 may also include short range wireless networks utilizing, e.g., BLUETOOTH™ and WI-FI™ technologies and protocols.

While the system 100 of FIG. 1 illustrates an embodiment in which the host system computer 106 implements applications for performing the collaborative planning described herein, it will be understood that at least a portion of the applications can be resident on and executable by the user devices 104. In addition, only three storage devices 102 and two user devices 104 are shown in the FIG. 1 for ease of illustration. It will be understood that any number of these devices can be employed in order to realize the advantages of the embodiments described herein.

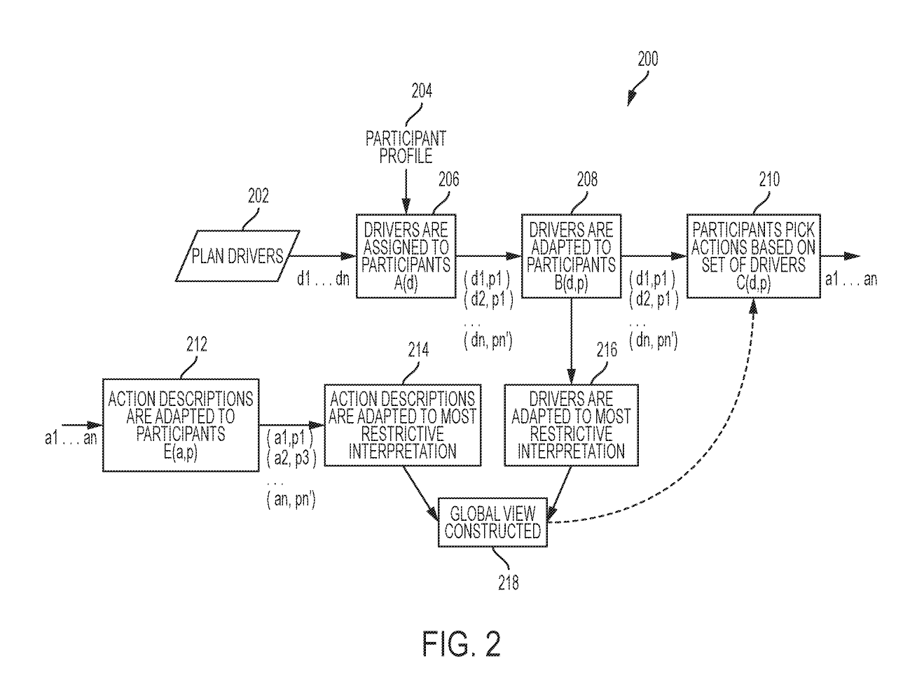

Turning now to FIG. 2 a data flow diagram of a process for implementing the collaborative planning will now be described in an embodiment. The following description is illustrative of collaborative planning in the health/social care industries in which a team of professionals is tasked with developing a plan for a vulnerable individual or household. The collaborative plan in this scenario would result in the identification of services that are needed to assist the individual or household.

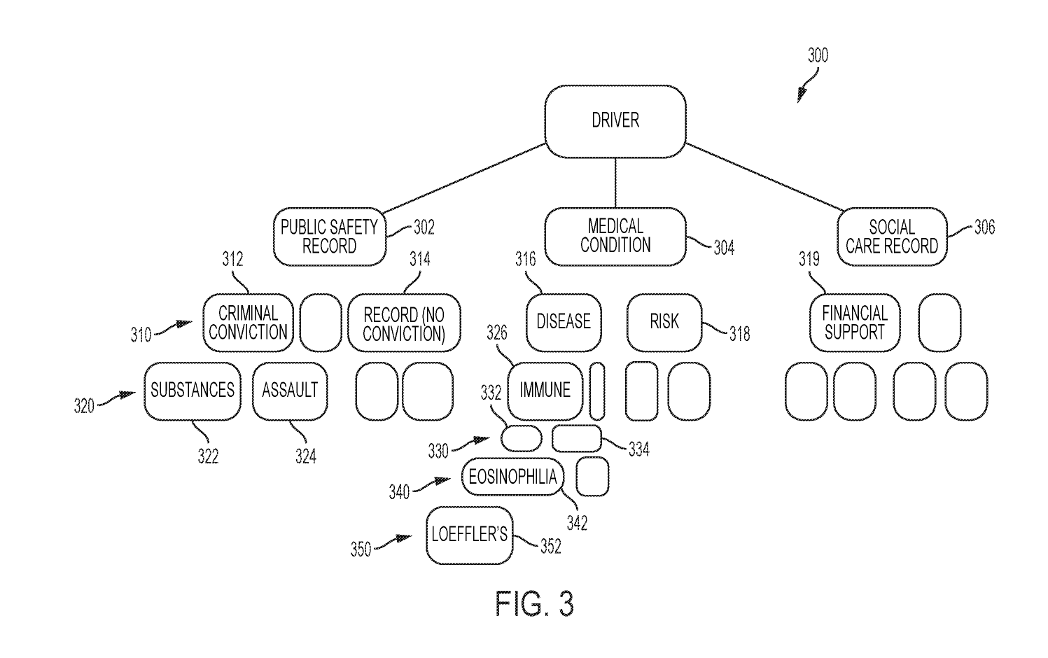

The process of FIG. 2 assumes that a hierarchy of drivers has been created for a multi-domain environment. In the health and social care fields, a hierarchy of drivers can be created from one or more taxonomies or corpus of information. These knowledge bases may be stored in one or more storage devices 102 of FIG. 1. As shown in FIG. 3, for example, a graphical representation of a portion of a hierarchy 300 of terms has been created from a social care taxonomy and a human disease ontology in which terms have been extracted from the knowledge bases. The hierarchy 300 of FIG. 3 illustrates a tiered set of nodes for three knowledge domains. The hierarchy 300 illustrates some empty nodes in order to simplify the Figure and for ease of description. It will be understood that all nodes shown in the Figure may contain terms from the knowledge bases.

The hierarchy 300 includes drivers extracted from three different knowledge domains: a public safety record 302, medical record 304, and social care record 306. These records 302, 304, and 306 may correspond to the databases described with respect to the storage devices 102 of FIG. 1.

Each level in the hierarchy 300, moving in a direction away from the top node, reflects terms (also referred to herein as ‘nodes’ and/or ‘drivers’) at increased specificity, which can sometimes translate to increased sensitivity of data. As shown in FIG. 3, in a first level 310, nodes associated with the public safety record 302 include criminal conviction 312, and record (no conviction) 314. Nodes associated with the medical record 304 include disease 316 and risk 318. Nodes associated with the social care record 306 include financial support 319.

In a second level 320 of the hierarchy 300, nodes associated with the public safety record 302 include substances 322 and assault 324, while nodes associated with the medical record 304 include immune 326.

In a third level 330 of the hierarchy 300, there are no nodes associated with either of the public safety record 302 or the social care record 306. However, unspecified nodes 332 and 334 are shown for medical record 304 at this level to illustrate that a level can exist for one domain but not for others.

In a fourth level 340 of the hierarchy 300, a node 342 associated with the medical record 304 is shown Likewise, in a fifth level 350, there exists a single node 352 associated with the medical record 304.

In an embodiment, the hierarchy 300 is input to subject information databases (also referred to as ‘subject databases’) to generate plan drivers for a subject of the collaborative plan. The subject information databases may include records that are particular to the subject of the plan (e.g., the vulnerable individual or household). For example, the subject information databases can be stored as records relating to the individual/subject in the storage devices 102 of FIG. 1.

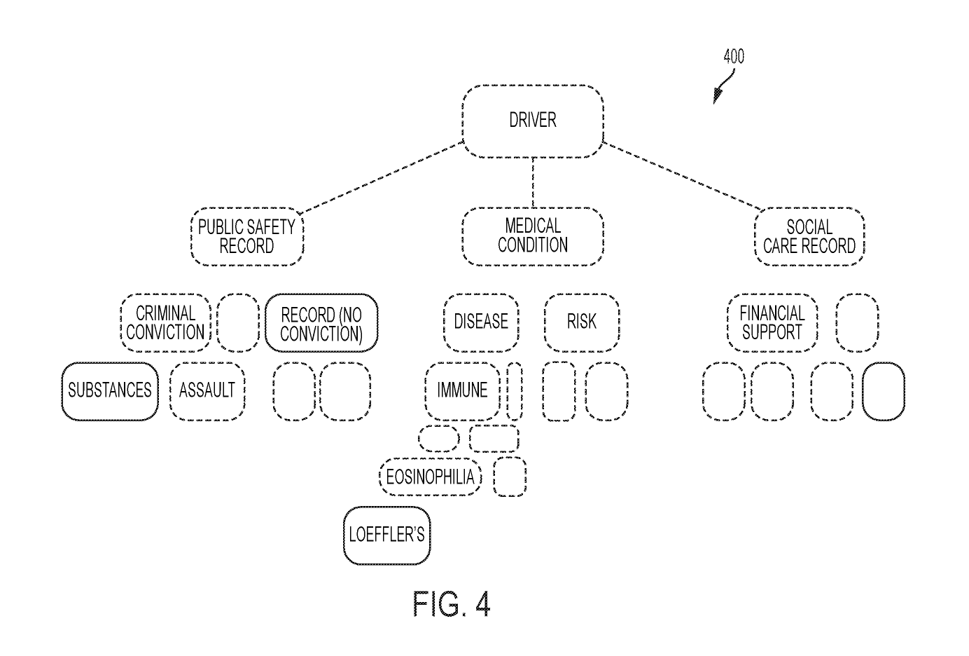

The application compares the data in the subject records to terms in the hierarchy 300, and matching information is used to generate a hierarchy (or a modification to the hierarchy 300) that is specific to the individual. The modified hierarchy is shown in FIG. 4 as hierarchy 400. In this hierarchy 400, terms encased by solid lines reflect matching data (i.e., data from the subject information databases that match terms in the hierarchy 300). The terms encased in the solid lines shown in FIG. 4 are referred to as ‘plan drivers’ with respect to the individual subject to the collaborative plan.

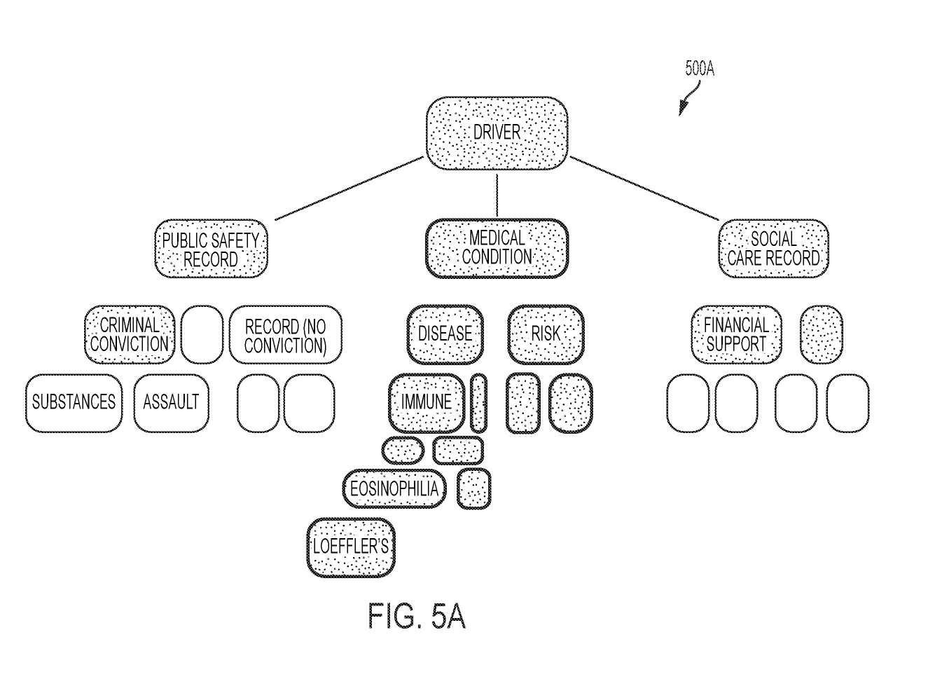

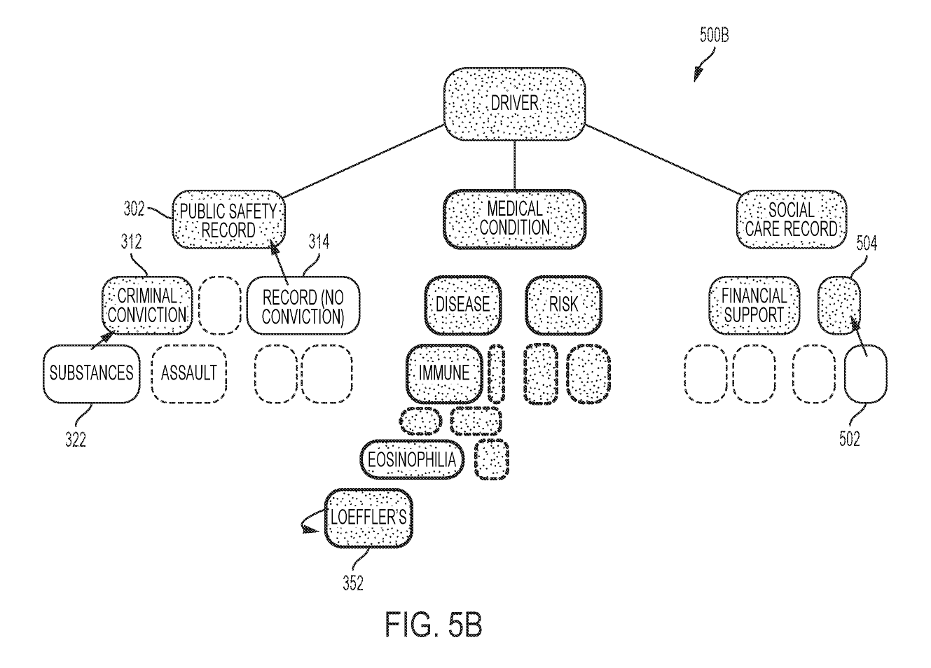

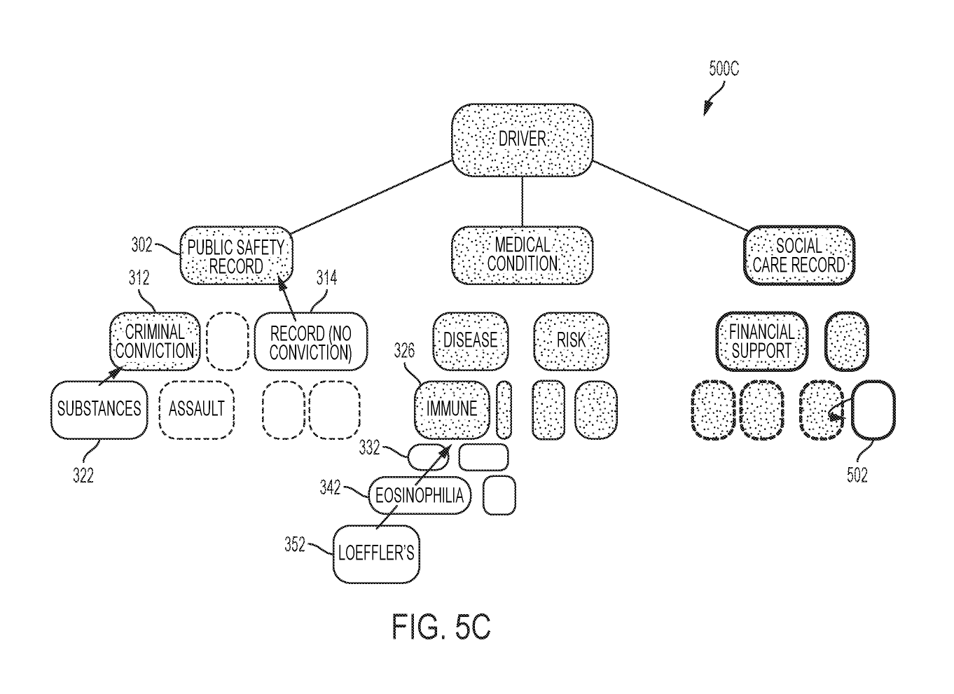

Returning to FIG. 2, the process 200 includes inputting the plan drivers 202 (d1 . . . dn), and user profiles 204 to the system for assignment of plan drivers to users (d1, p1)(d2,p2), etc. The user profiles may be generated as hierarchies similar to the hierarchy 300 of FIG. 3; however, instead of using the subject information databases in the processing, a user's skill profile can be used as input to the system. The skill profile may include work experience, education, specialties or concentrations, etc. A sample user profile (illustrated as a hierarchy 500A) for a physician or nurse is shown in FIG. 5A. Shaded terms in the profile indicate that the terms are relevant to the professional, and terms that are shaded and include a thick border indicate that the profile is primarily concerned with these terms. As can be seen in the Figure, all medical information is relevant, while only a portion of the public safety information and social care is relevant.

The application adapts the plan drivers to more general terms for each of the users 208, as dictated by the users' profiles. For example, the terms in the hierarchy 500 for the physical or nurse are changed to the most specific level that is in the user's profile. A sample hierarchy 500B illustrating this adaptation is shown in FIG. 5B. As can be seen in FIG. 5B, the term substances 322 is masked as it is not particularly relevant to the professional. For example, the node 312 will be shown to the professional, but the node 322 will not be shown to the professional. Also, in FIG. 5B, node 352, which is the lowest node in the hierarchy, is considered relevant and so it remains viewable to the professional. Finally, node 502 is masked because it is not relevant for the professional. Thus, the professional will be able to view the node 504, which corresponds to the node 502 at a higher level of generalization.

FIG. 5C reflects a hierarchy 500C created for a different professional (i.e., a social care worker) but with respect to the same subject and plan drivers. As shown in FIG. 5C, the hierarchy 500C illustrates different nodes as being relevant to the social care worker as compared to the physician/nurse, as illustrated in FIGS. 5A and 5B. Similar to FIG. 5B, the hierarchy 500C shows an adaptation specific to the social worker in which, e.g., node 322 is masked, and nodes 352, 342, and 332 are masked, such that the professional can view nodes only at level 310 for the public safety record, level 320 for the medical record, and all levels (310 and 320) for the social care record.

In an embodiment, a set of instructions for performing the above-referenced adaptation can be implemented as follows:

```
Set<Term> adapt(Set<Term> P, Set <Term> D){
Set<Term> adaptedDrivers;
for (d:D) {
  while (!P.contains(d)) {
    d=d.parent( );
  }
  if (d!=null)//Root has no parent
    adaptedDrivers.add(d);
  }
}
return adaptedDrivers;
}
```

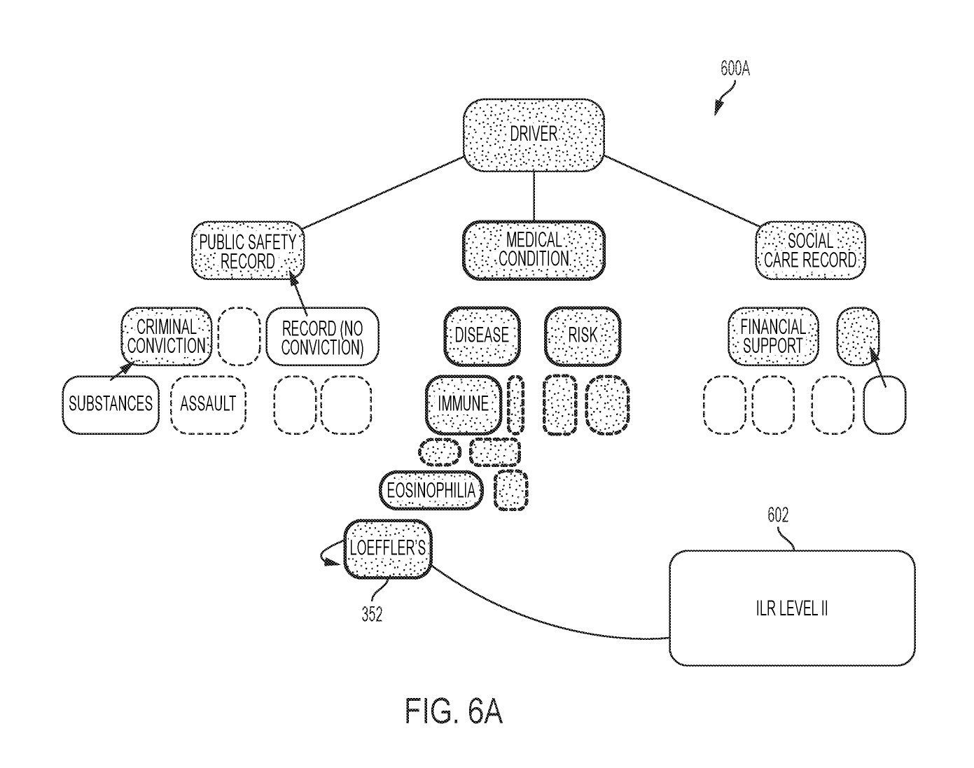

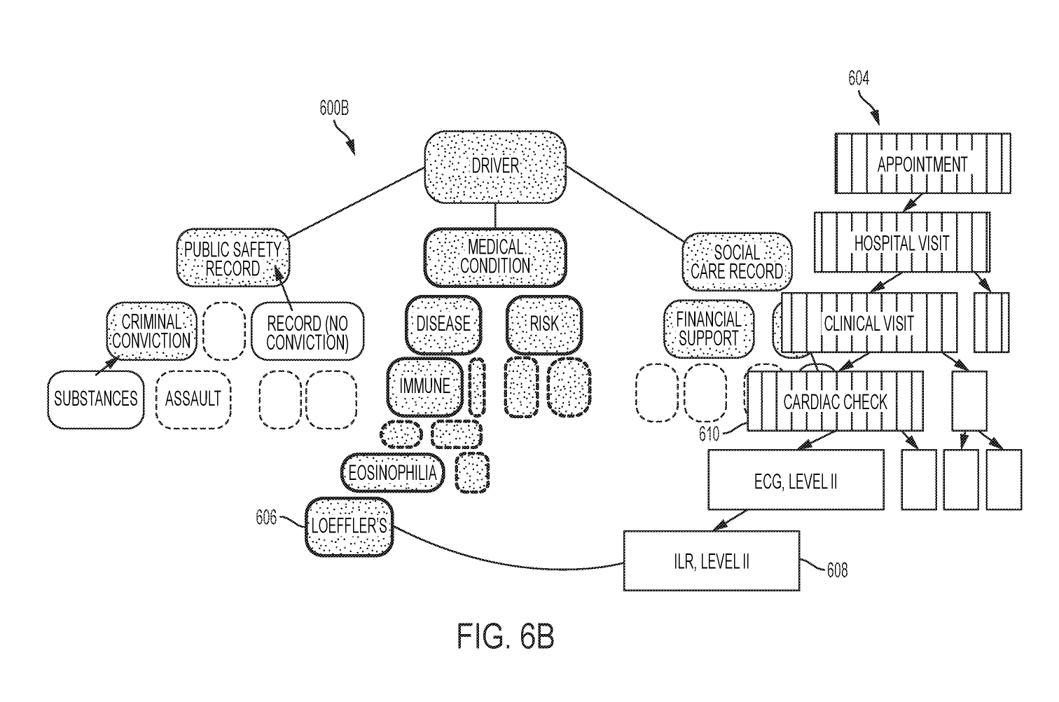

Returning to FIG. 2, the application assigns actions to the users 210. In one embodiment, the actions may be mapped or linked via database structures to the terms or nodes in the hierarchies, such that when a user selects a node, one or more associated actions can be presented to the user for selection. As shown in FIG. 6A, for example, a hierarchy 600A created for a physician or nurse is presented in which the user selects a node 352 and a corresponding action is presented 602. The actions can be linked to the nodes based on known guidelines for a particular domain. Alternatively, the user may search for relevant actions, based on their experience and knowledge. The actions are adapted for the particular users 212. As shown in FIG. 6B, a hierarchy 600B illustrates a separate, overlaid hierarchy 604 of actions for user viewing and, potentially, selection. The users may view actions of other users, but the actions viewed may be generalized based on their profiles. For example, a physician selects a plan driver 606 and hierarchy 604 may show all nodes (shaded and unshaded). Thus, a physician who selects plan driver 606 may see (and select) an action “ILR Level II 608; whereas another user (e.g., a police officer) may see a more generalized version of the hierarchy 604, e.g., the shaded portions only. The most specific node in the hierarchy that may be viewed by the police officer would be Cardiac Check 610.

From these processes, a customized view of the collaborative plan can be provided for each of the users in which only plan drivers and assigned actions relevant to the users are presented.

In an embodiment, the application can generate a global view 218 of the collaborative plan that includes relevant information to the users, as well as information provided at a generalized level in order to protect sensitive data concerning the subject of the plan. The application adapts all assigned actions to the users 214 to their most restrictive interpretation and adapts the plan drivers to their most restrictive interpretation 216. The adaptations can be implemented similar to the driver adaptations described above. The global view can be created from these adaptations 214 and 216.

As indicated above, the collaboration planning processes enables individuals having domain expertise across a multitude of different knowledge domains to collaborate on the development of a plan by receiving or accessing only information that is relevant and necessary to that domain expert. The collaborative planning processes provide customized views of a plan directed to each domain expert, as well as provide a global view of the plan at a level of generalization that prevents unnecessary exposure of sensitive information. The processes may include receiving a set of plan drivers for creating a collaborative plan. The set of plan drivers collectively span multiple knowledge domains.

The processes also include receiving a set of user profiles, each of which specifies domain-specific data elements attributed to corresponding users who are tasked with carrying out aspects of the collaborative plan. The domain-specific data elements correspond to one or more of the multiple knowledge domains.

The processes also include mapping each of the plan drivers to one or more of the users based on a relationship between the plan driver and the corresponding domain-specific data elements of the one or more users, and assigning one or more actions to each mapped plan driver. The actions are configured to facilitate an objective defined via the collaborative plan.

For each of the users, the processes include creating a customized computer-implemented view of the collaborative plan that includes a user-directed corresponding one or more mapped plan driver and a corresponding one or more assigned action, and creating, for collective viewing by the users, a global computer-implemented view of the collaborative plan. The global view is created from adapting each of the mapped plan drivers and corresponding assigned actions to a generalized level that is based on collective user profiles.

The processes also include creating the set of plan drivers. Creating the plan drivers includes creating a graphical representation of a hierarchy of terms (or a set of hierarchies of terms) from knowledge bases corresponding to the multiple knowledge domains, wherein each succeeding level in the hierarchy below a top level includes terms of increased specificity, inputting the hierarchy to a subject database that stores aspects of a subject of the collaborative plan, identifying data in the subject database that matches terms in the hierarchy, and outputting a graphical representation of a modified hierarchy that includes matching terms, the matching terms representing the plan drivers.

The mapping also includes inputting the user profiles to a database storing the modified hierarchy, and identifying data in the modified hierarchy that match the domain-specific data elements of the user profiles. Creating the customized computer-implemented view of the collaborative plan includes providing for each of the users, via an interface having access limited to a respective user, only the user-directed corresponding one or more mapped plan driver and the corresponding one or more assigned action.

Creating the customized view further includes traversing the modified hierarchy from a lowest level upward and selecting only those plan drivers residing at a level in which a corresponding plan driver falls within the domain-specific data elements of a corresponding user profile.

The assigning actions includes accessing a database storing a hierarchy of actions defined for the plan driver, inputting the user profiles to the database storing the hierarchy of actions, identifying data in the hierarchy of actions that falls within the domain-specific data elements of the user profiles, and outputting a modified hierarchy of actions for each of the users.

The assigning actions also includes receiving, from an interactive component of the customized computer-implemented view, user selections of actions for each of the plan drivers associated with the user.

Technical effects and benefits include collaborative planning in a multi-domain environment. The collaborative planning enables individuals having domain expertise across a multitude of different knowledge domains to collaborate on the development of a plan by receiving or accessing only information that is relevant and necessary to that domain expert. The collaborative planning processes provide customized views of a plan directed to each domain expert, as well as provide a global view of the plan at a level of generalization that prevents unnecessary exposure of sensitive information.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
receiving, at a computer, a set of plan drivers for creating a collaborative plan, the set of plan drivers collectively spanning multiple knowledge domains;
receiving a set of user profiles, each of the user profiles specifying domain-specific data elements attributed to corresponding users who are tasked with carrying out aspects of the collaborative plan, the domain-specific data elements corresponding to one or more of the multiple knowledge domains;
mapping, by the computer, each of the plan drivers to one or more of the user profiles based on a relationship between the plan driver and the corresponding domain-specific data elements of the one or more users;
assigning one or more actions to each mapped plan driver, the one or more actions configured to facilitate an objective defined via the collaborative plan;
for each of the users, creating a customized computer-implemented view of the collaborative plan, the customized view including a user-directed corresponding one or more mapped plan driver and a corresponding one or more assigned action; and
creating, for collective viewing by the users, a global computer-implemented view of the collaborative plan, the global view created from adapting each of the mapped plan drivers and corresponding assigned actions to a generalized level that is based on collective user profiles.

2. The method of claim 1, further comprising creating the set of plan drivers, comprising:
creating a graphical representation of a hierarchy of terms from knowledge bases corresponding to the multiple knowledge domains, wherein each succeeding level in the hierarchy below a top level includes terms having increased specificity;
inputting the hierarchy to a subject database that stores aspects of a subject of the collaborative plan;
identifying data in the subject database that matches terms in the hierarchy; and
outputting a graphical representation of a modified hierarchy that includes matching terms, the matching terms representing the plan drivers.

3. The method of claim 2, wherein the mapping includes:
inputting the user profiles to a database storing the modified hierarchy; and
identifying data in the modified hierarchy that match the domain-specific data elements of the user profiles;
wherein creating the customized computer-implemented view of the collaborative plan includes providing for each of the users, via an interface having access limited to a respective user, only the user-directed corresponding one or more mapped plan driver and the corresponding one or more assigned action.

4. The method of claim 3, wherein the creating the customized view further comprises traversing the modified hierarchy from a lowest level upward and selecting only those plan drivers residing at a level in which a corresponding plan driver falls within the domain-specific data elements of a corresponding user profile.

5. The method of claim 1, wherein the assigning one or more actions includes, for each of the plan drivers:
accessing a database storing a hierarchy of actions defined for the plan driver;
inputting the user profiles to the database storing the hierarchy of actions;
identifying data in the hierarchy of actions that falls within the domain-specific data elements of the user profiles; and
outputting a modified hierarchy of actions for each of the users;
wherein in response to the adapting each of the corresponding assigned actions to a generalized level, the outputting the modified hierarchy includes providing a view of the actions, at varying levels of generalization, for each of the users.

6. The method of claim 1, wherein the assigning one or more actions includes receiving, from an interactive component of the customized computer-implemented view, user selections of actions for each of the plan drivers associated with the user.

7. The method of claim 1, wherein the multiple knowledge domains include health care, social welfare, and government agencies, and the user profiles are directed to professionals working in health care, social care, and law enforcement.

8. A system, comprising:
a memory having computer readable instructions; and
a processor for executing the computer readable instructions, the computer readable instructions including:
receiving a set of plan drivers for creating a collaborative plan, the set of plan drivers collectively spanning multiple knowledge domains;
receiving a set of user profiles, each of the user profiles specifying domain-specific data elements attributed to corresponding users who are tasked with carrying out aspects of the collaborative plan, the domain-specific data elements corresponding to one or more of the multiple knowledge domains;
mapping each of the plan drivers to one or more of the user profiles based on a relationship between the plan driver and the corresponding domain-specific data elements of the one or more users;
assigning one or more actions to each mapped plan driver, the one or more actions configured to facilitate an objective defined via the collaborative plan;
for each of the users, creating a customized computer-implemented view of the collaborative plan, the customized view including a user-directed corresponding one or more mapped plan driver and a corresponding one or more assigned action; and
creating, for collective viewing by the users, a global computer-implemented view of the collaborative plan, the global view created from adapting each of the mapped plan drivers and corresponding assigned actions to a generalized level that is based on collective user profiles.

9. The system of claim 8, wherein the computer readable instructions further include creating the set of plan drivers, comprising:
creating a graphical representation of a hierarchy of terms from knowledge bases corresponding to the multiple knowledge domains, wherein each succeeding level in the hierarchy below a top level includes terms having increased specificity;
inputting the hierarchy to a subject database that stores aspects of a subject of the collaborative plan;
identifying data in the subject database that matches terms in the hierarchy; and
outputting a graphical representation of a modified hierarchy that includes matching terms, the matching terms representing the plan drivers.

10. The system of claim 9, wherein the mapping includes:
inputting the user profiles to a database storing the modified hierarchy; and
identifying data in the modified hierarchy that match the domain-specific data elements of the user profiles;
wherein creating the customized computer-implemented view of the collaborative plan includes providing for each of the users, via an interface having access limited to a respective user, only the user-directed corresponding one or more mapped plan driver and the corresponding one or more assigned action.

11. The system of claim 10, wherein creating the customized view further comprises traversing the modified hierarchy from a lowest level upward and selecting only those plan drivers residing at a level in which a corresponding plan driver falls within the domain-specific data elements of a corresponding user profile.

12. The system of claim 8, wherein the assigning one or more actions includes, for each of the plan drivers:
accessing a database storing a hierarchy of actions defined for the plan driver;
inputting the user profiles to the database storing the hierarchy of actions;
identifying data in the hierarchy of actions that falls within the domain-specific data elements of the user profiles; and
outputting a modified hierarchy of actions for each of the users;
wherein in response to the adapting each of the corresponding assigned actions to a generalized level, the outputting the modified hierarchy includes providing a view of the actions, at varying levels of generalization, for each of the users.

13. The system of claim 8, wherein the assigning one or more actions includes receiving, from an interactive component of the customized computer-implemented view, user selections of actions for each of the plan drivers associated with the user.

14. The system of claim 8, wherein the multiple knowledge domains include health care, social welfare, and government agencies, and the user profiles are directed to professionals working in health care, social care, and law enforcement.

15. A computer program product comprising a computer readable storage medium having program instructions embodied therewith, wherein the computer readable storage medium is not a transitory signal per se, the program instructions executable by a computer processor to cause the computer processor to perform a method comprising:
receiving a set of plan drivers for creating a collaborative plan, the set of plan drivers collectively spanning multiple knowledge domains;
receiving a set of user profiles, each of the user profiles specifying domain-specific data elements attributed to corresponding users who are tasked with carrying out aspects of the collaborative plan, the domain-specific data elements corresponding to one or more of the multiple knowledge domains;
mapping each of the plan drivers to one or more of the user profiles based on a relationship between the plan driver and the corresponding domain-specific data elements of the one or more users;
assigning one or more actions to each mapped plan driver, the one or more actions configured to facilitate an objective defined via the collaborative plan;
for each of the users, creating a customized computer-implemented view of the collaborative plan, the customized view including a user-directed corresponding one or more mapped plan driver and a corresponding one or more assigned action; and
creating, for collective viewing by the users, a global computer-implemented view of the collaborative plan, the global view created from adapting each of the mapped plan drivers and corresponding assigned actions to a generalized level that is based on collective user profiles.

16. The computer program product of claim 15, wherein the program instructions are further executable by a computer processor to cause the computer processor to perform creating the set of plan drivers, comprising:
creating a graphical representation of a hierarchy of terms from knowledge bases corresponding to the multiple knowledge domains, wherein each succeeding level in the hierarchy below a top level includes terms having increased specificity;
inputting the hierarchy to a subject database that stores aspects of a subject of the collaborative plan;
identifying data in the subject database that matches terms in the hierarchy; and
outputting a graphical representation of a modified hierarchy that includes matching terms, the matching terms representing the plan drivers.

17. The computer program product of claim 16, wherein the mapping includes:
inputting the user profiles to a database storing the modified hierarchy; and
identifying data in the modified hierarchy that match the domain-specific data elements of the user profiles;
wherein creating the customized computer-implemented view of the collaborative plan includes providing for each of the users, via an interface having access limited to a respective user, only the user-directed corresponding one or more mapped plan driver and the corresponding one or more assigned action.

18. The computer program product of claim 17, wherein creating the customized view further comprises traversing the modified hierarchy from a lowest level upward and selecting only those plan drivers residing at a level in which a corresponding plan driver falls within the domain-specific data elements of a corresponding user profile.

19. The computer program product of claim 15, wherein the assigning one or more actions includes, for each of the plan drivers:
accessing a database storing a hierarchy of actions defined for the plan driver;
inputting the user profiles to the database storing the hierarchy of actions;
identifying data in the hierarchy of actions that falls within the domain-specific data elements of the user profiles; and
outputting a modified hierarchy of actions for each of the users;
wherein in response to the adapting each of the corresponding assigned actions to a generalized level, the outputting the modified hierarchy includes providing a view of the actions, at varying levels of generalization, for each of the users.

20. The computer program product of claim 15, wherein the assigning one or more actions includes receiving, from an interactive component of the customized computer-implemented view, user selections of actions for each of the plan drivers associated with the user.
